(19) United States
(12) Patent Application Publication
(10) Pub. No.: US 2007/0271503 A1
(43) Pub. Date: Nov. 22, 2007

(54) INTERACTIVE LEARNING AND ASSESSMENT PLATFORM

(75) Inventors: Margaret Harmon, San Diego, CA (US); Michelle A. Youngers, San Diego, CA (US); Donald Mackay, Solana Beach, CA (US)

Correspondence Address: PILLSBURY WINTHROP SHAW PITTMAN LLP, ATTENTION: DOCKETING DEPARTMENT, P.O BOX 10500, McLean, VA, 22102, US

(73) Assignee: SCIENCEMEDIA INC., San Diego, CA (US)

(21) Appl. No.: 11/751,609

(22) Filed: May 21, 2007

Related U.S. Application Data
(60) Provisional application No. 60/802,058, filed on May 19, 2006.

(51) Int. Cl. G06F 17/00

(52) U.S. Cl. 715/512; 715/515; 715/500.1

(57) ABSTRACT

Systems and methods are described for annotating documents. A document image is annotated in selected portions stored with annotation tabs and associated information in an annotated document file. A wizard is described for selecting portions, creating annotation tabs and linking annotation information to the document image. The information includes multimedia content and multimedia players are identified for playing the multimedia content. Systems and methods are described that provide interactive learning based on an annotated image of a document. Automatic and manual navigation of the document image and its annotations are described. A system is described for facilitating interactive learning and assessment that comprises a plurality of annotations to a document, and a presentation tool configured to display an image of the document and content provided by a selected annotation

### CROSS-REFERENCE TO RELATED APPLICATIONS

This Application claims priority to and incorporates by reference herein U.S. Provisional Application Ser. No. 60/802,508 filed May 19, 2006 and entitled “INTERACTIVE LEARNING ASSESSMENT PLATFORM.”

### BACKGROUND OF THE INVENTION

1. Field of the Invention

The present invention relates generally to interactive learning systems and more particularly to interactive learning systems based on complex documents.

2. Description of Related Art

In many fields, sales representatives generally require substantial training and assessment before they can be qualified for selling products. In fields such as pharmaceutical sales, representatives must typically be trained on documents that are critical to product knowledge and be able to use reprints effectively despite being required to learn them through ineffective traditional training methods such as text-based or reading or classroom-based training that covers the reprint. These documents are typically clinical reprints, but can include visual aids, abstracts or other technical documents.

### BRIEF SUMMARY OF THE INVENTION

Certain embodiments of the invention provide tools to assist in training and assessing of sales representatives and other employees on documents that are, for example, critical to job performance. In certain embodiments, the documents can be clinical reprints, and can include visual aids, abstracts or other complex financial, legal and technical documents. Certain embodiments of the invention provide tools that can help users learn material within the context of the document itself. In many embodiments, this technique may be characterized as context-based learning.

Certain embodiments provide systems and methods for annotating documents, comprising scanning a document to obtain a document image, annotating selected portions of the document and storing the document image, the annotation tabs and the associated information in an annotated document file. In certain embodiments, annotating each portion includes identifying a location of the each portion, generating annotation tabs for the each portion, and associating the annotation tabs with information related to a region of the document corresponding to the each portion. In certain embodiments, the information includes multimedia content and the associating includes identifying a multimedia player for playing the multimedia content.

In certain embodiments, a method for interactive learning is provided that comprises providing an image of a document to a user, wherein a portion of the image is linked to annotations to the document, providing annotation tabs, each tab identifying one of the linked annotations, and responsive to selection of an annotation tab, presenting the annotation identified by the selected annotation tab. In certain embodiments, the selection of the selected annotation tab is made by the user.

In certain embodiments, a system for interactive learning and assessment is provided that comprises a plurality of annotations to a document, and a presentation tool configured to display an image of the document and content provided by a selected annotation, wherein the annotation is selected from the annotated image, wherein portions of the image are highlighted and linked to corresponding ones of the annotations. In certain embodiments, the system comprises a wizard component configured to identify additional portions of the image for highlighting and further configured to create links between the additional portions and information associated with corresponding regions of the document.

### BRIEF DESCRIPTION OF THE DRAWINGS

The present invention is illustrated by way of example, and not limitation, in the figures of the accompanying drawings in which like references denote similar elements, and in which:

FIG. 1 illustrates an example of a standalone embodiment of the invention;

FIG. 2 illustrates an example of a networked embodiment of the invention;

FIG. 3 illustrates an example of process used to create annotated documents;

FIG. 4 depicts a simplified user interface in one embodiment of the invention;

FIG. 5 is an example of a process used to review an annotated document; and

FIGS. 6-12 are screenshots captured in one example of an embodiment of the invention.

### DETAILED DESCRIPTION OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration. In particular, the present invention is applicable in many fields including education, sales training and general product training. However, for the purposes of this description, an example of pharmaceutical sales training will be described.

Certain embodiments of the invention provide tools to assist in training and assessing of sales representatives and other employees on documents that are, for example, critical to product knowledge. In certain embodiments, the documents can be clinical reprints, and can include visual aids, abstracts or other technical document. Certain embodiments of the invention provide a tool (the “Annotator”) that can help users learn material within the context of the document itself. In many embodiments, this technique may be characterized as context-based learning.

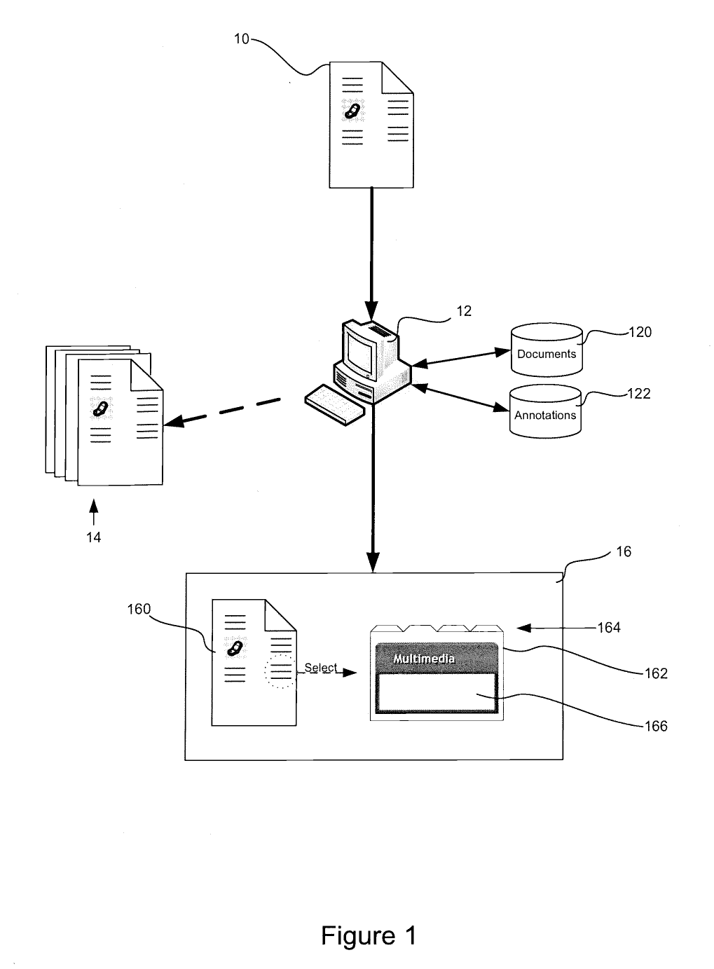

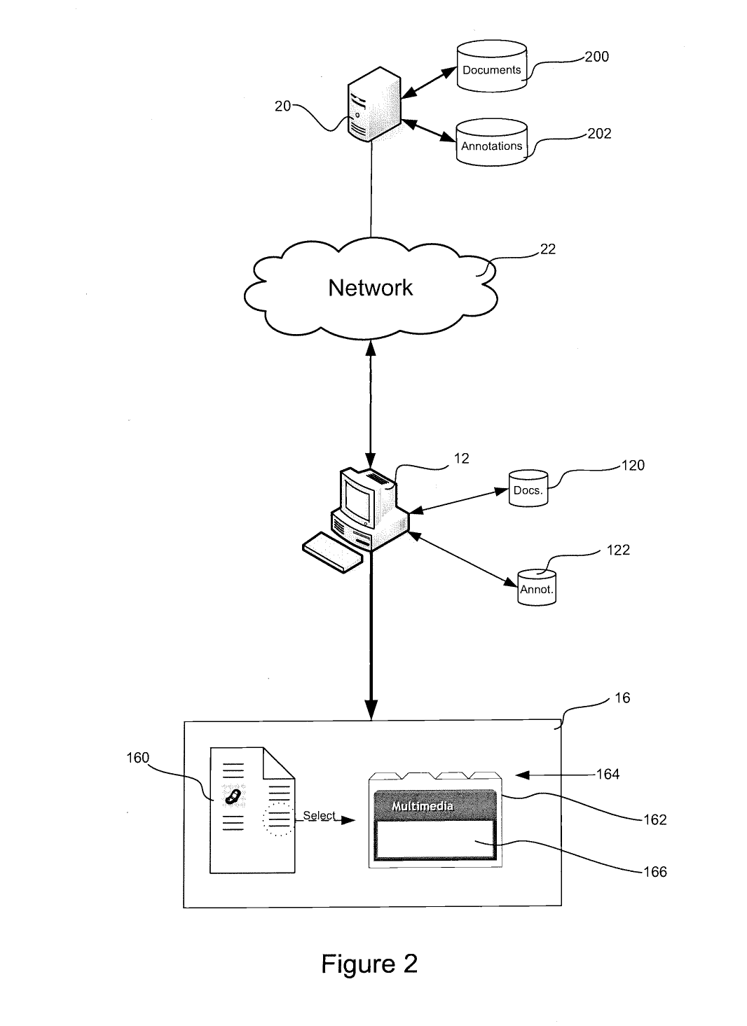

FIGS. 1 and 2 illustrate a simplified example of embodiments of the invention. Computing system 10 can comprise any combination of computers, PDAs, terminals, monitors and display systems necessary to present information to one or more persons. For the purposes of discussion, computing system 12 will be described as operating substantially independently of a network to annotate and present a document 10 in a learning/assessment environment as depicted in FIG. 1. It will be appreciated however, that computing system 10 will typically be configurable to interact with local 120 and networked document stores 200 and may provide annotated documents and intermediate products 14 to other systems using shared, local and/or removable storage (200 and 202) as depicted in FIG. 2. In certain embodiments, a server 20 may provide documents from storage 200 to system 12 for annotation. In some embodiments, server 20 may provide documents 200 together with annotations 202 for presentation by system 12.

Combinations of the annotated and base documents may be provided for customization by system 12. In one example, system 12 may compile or select documents of interest to one or more users and may assemble annotations and annotated documents based on the compiled or selected documents. In another example, annotations and documents may be compiled or selected at system 12 (or a server 20) to provide documents that are relevant to the user. For example, documents may be compiled or selected based on regional factors (e.g. local regulations), language, time of year and customer-related information.

Presentations maybe assembled from intermediate products 14. Intermediate products can include any non-final form materials. Intermediate products 14 are typically maintained in a form that can be rendered for display on later-identified display systems and can be provided as a specialized file format. Intermediate products may also include links and associations between documents. For example, original documents may be stored locally or identified by an address where the document can be located on a network. Annotations, images of the original documents and annotated images of the original documents may be maintained locally or referenced in networked or other storage. Thus, a presentation may be assembled for display on a desired display system or computer system where the presentation is assembled by obtaining a set of original documents of interest, identifying and obtaining corresponding annotations and images, and combining and ordering the various components.

Computing system 10 can display, or cause to be displayed, an interactive presentation 16 that can include an annotated rendition 160 of input document 10 and one or more related associated displays 162 providing information corresponding to selected annotations in the annotated document 160. For certain annotations in the annotated document 160, multiple annotations may be displayed concurrently, sequentially and/or selectively by, for example, associating each annotation with a tab 164 or, list entry, icon, etc.

Computing system 10 may maintain documents 120 and corresponding and/or associated annotations in a local 122 or networked storage 202. Annotations may be generated by computing system 12 and may additionally or alternatively include annotations 202 imported from another system using a network or removable storage such as optical disk (DVD-ROM, CD-ROM, etc), flash card, external drive, etc. Where annotations are generated by computing system 10, annotated documents and intermediate products 14, as well as original documents 10 and annotations 122 can be exported to other systems.

In certain embodiments, annotation tools and review/assessment tools can at least partially be provided as a network service. Thus a server 20 may respond to user requests provided by computing device 12 communicated through network 22. The user may interface with the system using a commonly available web browser or any other commercially available or proprietary client software. The server 20 may maintain one or more databases of documents, document images, annotated documents and annotations and annotation content. In some embodiments, the server 20 may maintain network links to one or more databases of documents, document images, annotated documents and annotations and annotation content. Some of these embodiments, capabilities to mobile device users by offloading requirements to maintain large quantities of data and performance of complex searches and multimedia rendering. For example, a video file may be provided to a cellular telephone by streaming the video content rather than transferring a video file to the telephone.

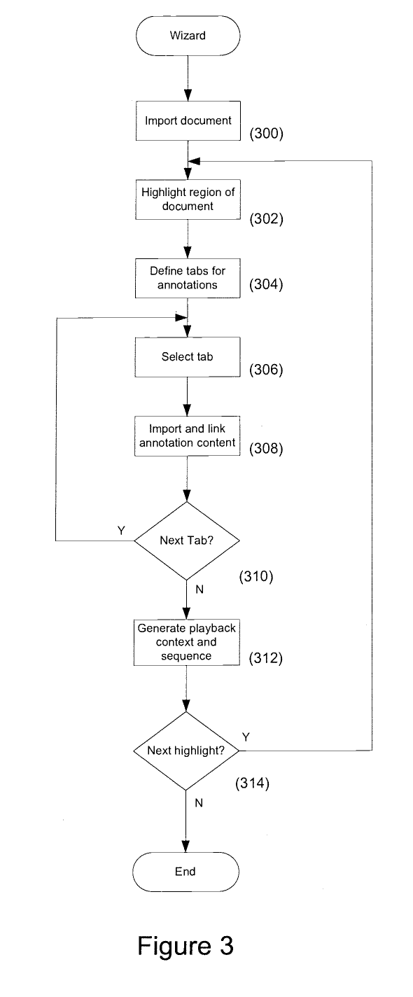

FIG. 3 shows a process that can be used to produce an annotated document according to aspects of the present invention. In certain embodiments, the process can be formalized and implemented as a wizard tool to support annotation of documents. At step 300, a document for annotation is imported. The document may be scanned to produce a digital image that can serve as a basis document for annotation. The digital image may also be produced from electronic documents such as “PDF,” word processing documents (e.g. Microsoft Word), presentation or graphics documents or from any document that can be rendered to a digital image.

The document in image form can then be presented to an operator for annotation. At step 302, a region of interest in the image can be selected or otherwise identified for annotation. The region of interest is typically identified visually by an operator or user of the wizard or annotation tool. However, in some embodiments, optical recognition tools can be used to prompt or select areas of interest. For example, an optical character recognition (“OCR”) tool can be employed to identify candidates or hotspots in the document that may require or suggest annotation. In one example, in annotating a tax return form, the OCR tool could identify regions of the image containing the words “income” and “expense.” In another example, images may be discernible within text regions based on density of darkness or color or through pattern recognition. Patterns of text may be identified as generally parallel lines, perhaps having a low density of darkness or color, wherein each of the parallel lines is separated by white space of certain dimension; graphics within the image document may be characterized as lacking such structures and patterns. In some embodiments, identifying patterns can be implanted in a document or document image. For example, a bar code or pattern can be superimposed on graphics or placed in a margin of the document.

In certain embodiments, a region can be highlighted by marking at least a portion of the perimeter of the region. A mouse or other pointing device can be used to identify the boundary which may have any desired shape including square, rectangular, polygonal, circular, elliptical and irregular shapes (e.g. freehand). The region may include multiple separate or adjacent subregions; for example, a picture and associated text could be part of a region, yet have no overlapping common area.

In certain embodiments, the perimeter of a region is described using a coordinate system. The region can be identified by one or more pages in which it falls, and by at least one coordinate locating the region on a page. For a circular region, coordinates may identify the location center of a circle and a corresponding radius length can be used to circumscribe the region. For a square, the coordinates of a predetermined corner (e.g. bottom right) together with the size of a side is sufficient to describe the region. It will be appreciated that any of the commonly used schemes for drawing a shape can be used to describe and locate a region of any type and form.

In certain embodiments, an annotated region can be added to the digital image of a document. Attributes of the region can be adjusted as desired to conceal or reveal the region as desired. Attributes can include contrast and foreground and/or background colors. In some embodiments, the location and shape of annotated regions can be maintained separately from the image. In the latter case, highlights can be applied as necessary based on information cross-referenced to annotation data. Upon display of a page, the annotated regions on the page can be identified and the image of the page modified to show the regions of interest. Modifications can include any combination of drawing lines around regions, modifying image contrast, adding or deleting color and so on. Upon selection, the highlighting may be intensified or augmented. For example, a selected annotated region could be magnified relative to the remaining portion of the document and/or the visibility of image unassociated with the highlighted region could be obscured or suppressed.

At step 304, one or more annotations can be outlined and/or identified. In one example, tabs can be created for each annotation that can be anticipated for the currently highlighted region. The tabs typically reference information and corresponding tools for presenting the information. For example, the information may include video content and a current tab (164) may associate a multimedia player 166 with the video content. Although a tab will typically identify the highlighted region, a type of information for presentation and at least one presentation tool, more generic tabs can be provided in which information type and presentation tool can be defined later. In some embodiments, additional annotations can be made at later stages in the process by inserting, cloning an annotation and/or by copying tab outlines. Similarly, many embodiments permit the deletion of initially defined tabs and the reassignment of tabs to other annotated regions of the document image. In at least some embodiments, predefined sets of tabs can be used to initialize an annotation outline of the document.

At step 306, each tab is selected in turn and the tab can be populated with information and presentation methods at step 308. In one example, information can be imported from any available source including local and network storage, the Internet, etc. and grouped within the tab. A presentation tool for each media type can be defined. Presentation tools can include multimedia players, HTML, XML and other markup language rendering tools, viewers provided by third party tool providers (e.g. Microsoft PowerPoint and Adobe PDF viewers) and custom developed presentation tools.

Tab selection and population is repeated until at step 310 it is determined that all tabs required for the currently selected highlighted region of the document image has been fully annotated. Optionally, at step 312, playback control information can be added to or otherwise associated with the annotation tabs provided for the currently selected highlighted region. Playback control can include playback sequence of tabs and/or information within one tab, conditional playback rules that may inhibit or enable certain information presentation based on predefined conditions and cross referencing information. In certain embodiments, playback control information creates contextual linkage between and within annotations and between annotations and viewing of the document image.

In certain embodiments, contextual linkage can permit viewers of the annotated document to review portions of annotations out of sequence. In this regard, the viewer may choose to reprise certain portions of the annotations in context of later viewed documents. In some embodiments, the contextual linkage comprises a contextual glossary. The contextual glossary may include a plurality of summaries generated for certain annotations. Summaries may be automatically generated during creation and development of the annotation tabs and may include manual entries, typically provided during annotation generation. Summaries may include summaries of individual annotation tabs, groups of annotation tabs corresponding to defined regions of a document image, summaries associated with a set of defined regions and summaries of annotations of complete documents. Individual entries in a contextual glossary can be provided as annotation tabs for certain defined regions of the document image.

In certain embodiments, summaries can be collated and provided as a precis of an annotated document. The precis can take the form of a “cheat sheet” identifying key information provided in the annotations. In this regard, the cheat sheet may be edited and customized for individual viewers based on each viewer's needs and priorities. The precis may be provided as a document abstract that can be multimedia in form, and may summarize certain of the annotations in a document. In certain embodiments, the precis can be downloaded to portable computing equipment including, for example, laptop computers, cellular telephones, PDAs, wireless Email clients, multimedia players and other portable devices.

In certain embodiments, an annotated document can be viewed in a contextual manner. Certain keyword, annotation, subject or content groupings can be searched or navigated. Typically, contextual viewing can be facilitated using a contextual glossary, as described above. Navigation and searching may include searching the annotations of an annotated document using selected entries of a contextual glossary to derive lists and/or maps of related regions of an annotated document.

At step 314, when it is determined that all annotation tabs associated with a currently highlighted region of the document image, a next region is highlighted for annotation. If at step 314, a next region is not identified, then the annotation of the document is completed. For each region, completion of annotation may include compiling an index of the annotations associated with the region, cross-referencing annotations associated with the region with other annotations associated with the region and creating contextual information associated with the region. The contextual information may include keywords, combination of keywords and predetermined context identifiers provided for annotations associated with the region.

After annotation of the identified regions in the document image, the annotation can be completed by indexing and cross-referencing annotations between regions of the document image. Furthermore, context of the document can be compiled by combining, collating contrasting and comparing the context associated with each of the regions of the document image. Thus, contextual information can be prioritized and accumulated and common context can be identified for various portions of the document.

Certain embodiments of the invention comprise a plurality of components including a learning tool (the “Annotator Tool”) that can present an annotated document in the same form as that provided to users in hard copy. The Annotator Tool can provide custom content comprising an image of the of the document along with related descriptive information and explanations in the form of text, graphics and animations, and a Wizard function that allows for the adding new material to the Tool.

In certain embodiments, the Annotator Tool presents a document or reprint in the same format that is used in hard copy. For example, a clinical paper that a sales representative may use when meeting with a physician can be reproduced and presented in identical form by the Annotator Tool. Important paragraphs, multimedia presentation or graphs can be highlighted and linked to explanatory information that aids in understanding the relevance of that portion of the document. The explanatory information may be any type of educational media, such as an animated graph, audio, text, graphics, etc. that relates to the learning objective. In the example of annotating a clinical reprint, the objectives may cover the selling point, background information needed to understand the key points, visualization of important concepts and a glossary with definitions and pronunciations. Learning efficiency can be increased because the close proximity of the instructional material to the relevant portions of the actual document can reduce extraneous cognitive load.

In certain embodiments, users of the learning tools can select which learning objectives are most relevant to them. In one example, a user may seek completion of background tutorial information if their existing knowledge is limited. In another example, a more knowledgeable user may prefer to limit review to key summary points. Annotation tabs can be provided as learning objective tabs that are entirely customizable to relate to the field associated with the user or the type of document being annotated. In addition, the functionality can allow for multiple documents to be contained, cataloged and accessed within the structure of the Annotator Tool.

In certain embodiments, the Annotator Tool can be delivered through the Internet (the web), CD, DVD, PDA, mobile device, and on any suitable multimedia platform. In many embodiments, the Annotator Tool can be provided and controlled using a learning management system. Typically, any type of printed document can be used with the Annotator Tool. In certain embodiments, the Annotator Tool “skin” can be modified to provide a look and feel consistent with a provider company, target company, service provider or other group and with product line or training course branding as required. In many embodiments, the Annotator Tool can be used to in any educational or training venue and for any industry type.

### The Annotator Tool as an Interactive Assessment (Document Knowledge) Tool

In certain embodiments, an Interactive Document Knowledge Tool is provided that comprises extended functionality and that can be used for web-based, interactive assessment. In one example, the Interactive Document Knowledge Tool can be configured to present a clinical reprint or any other document in the same form that the user can access in hard copy or by using the Annotator Tool. Through an interactive process of identification, ranking and descriptive text, the user's knowledge of the use of the document can be tested and/or recorded. In one example, each session can be reviewed by a third party such as a manager, instructor, etc. for the purpose of recording an assessment in some manner consistent with desired learning objectives.

In one example, the Interactive Document Knowledge Tool can mimic a training format commonly used by Pharmaceutical companies in classroom training whereby the Interactive Document Knowledge Tool comprises functionalities including:
An opening page may allow login or other identification and collection of information to link the user to the online tool and to a manager, teacher or coach.
A clinical reprint or other document (Abstract, Visual Aid, etc.) can appear within the frame, complete with navigation for “page turning” as necessary.
A series of questions appear that instruct the user on how to answer, such as (but not limited to) typed response, multiple choice, or highlighting certain related areas that correspond to the answer. Numbered arrows can be presented for the user to drag and drop onto the highlighted areas in order to rank their selections in order of importance.
The user can identify points of importance by highlighting specific areas of a paragraph within the document with highlighter functionality. Highlighter functionality is typically selectable from a toolbar, allowing for selection of color as well as but not limited to tools for arrows and other markup devices.
For each selection, the user can be prompted to formulate dialogue and type in a response to specific questions regarding their choice and ranking of the content.
When completed, a summary page can be prompted for completion of opening and closing dialogue to be used.

In certain embodiments, the Interactive Document Knowledge Tool can be adapted for use in multiple web-based venues including Web-X, company intranet or hosted web pages. In many embodiments, the Interactive Document Knowledge Tool visual design may be configured for a look and feel consistent with selected branding. In many embodiments, user friendly navigation functionality is provided. The Interactive Document Knowledge Tool may also have a Wizard function that can allow for customized use in selecting and importing documents and development of related assessment questions for each selected and imported document.

Referring now to FIG. 1, an example of an embodiment will be described with more particularity. In certain embodiments, an Annotator Tool operates in a standalone environment. A computer system 12 may use information received from, for example, a CD to provide content, customization and functionality. In certain embodiments, the Annotator Tool can be delivered through an LMS. In one example, the Annotator Tool and other tools can be used with no prior software installation beyond a standard browser and utilities such as Flash. In certain of these embodiments, the Annotator Tool supports mobile devices and PDAs that are capable of supporting Flash or any other suitable multimedia player or presentation. In certain of these embodiments, the Annotator Tool can be used to familiarize a user with the actual hard copy version of the article.

In certain embodiments, an Annotator Tool can be implemented using any suitable processing platform. In one example, a computer having XGA graphics, sound capabilities, Flash or any other multimedia program or platform and a current web browser (e.g. IE4+, Firefox 1+, etc) can typically be used. It will be appreciated that other platforms, including PDAs and other mobile devices can also be used. In certain embodiments, the Annotator Tool includes a component that teaches a user how to use difficult to understand literature to promote a product or to learn educational material. The Annotator Tool can describe the technical details and provides any background information needed for a user to understand the scientific or other details and appreciate the conclusions. The Annotator Tool can also directly relate the significance of results and conclusions to a product being promoted, although the use is not specific to commercial products.

In certain embodiments, the Annotator Tool enables a user to become intimately familiar with a hard copy version of a reprint. It will be appreciated that, in a sales situation, a salesperson is typically required to present the article and make sales points with the actual reprint in hand. Thus, the Annotator Tool can typically represent the article on the computer screen exactly as it is in hard copy.

In many embodiments, the Annotator Tool can support several annotation types as needed to document any given article. The following example illustrates identified annotation types relating to selling a product:
Key point: Why is this important to the integrity of the article?
Selling point: Why is this relevant to the product?
Visualization: Visual/animation aids that help understand what is going on better.
Background: What do I need to know to understand the significance of this?
Glossary: What jargon is used here that I may be unfamiliar with?
   In many embodiments, the Annotator Tool is configured to ensure that the citation for each article is complete and accurate. In many embodiments, customer branding is provided in the Annotator Tool.

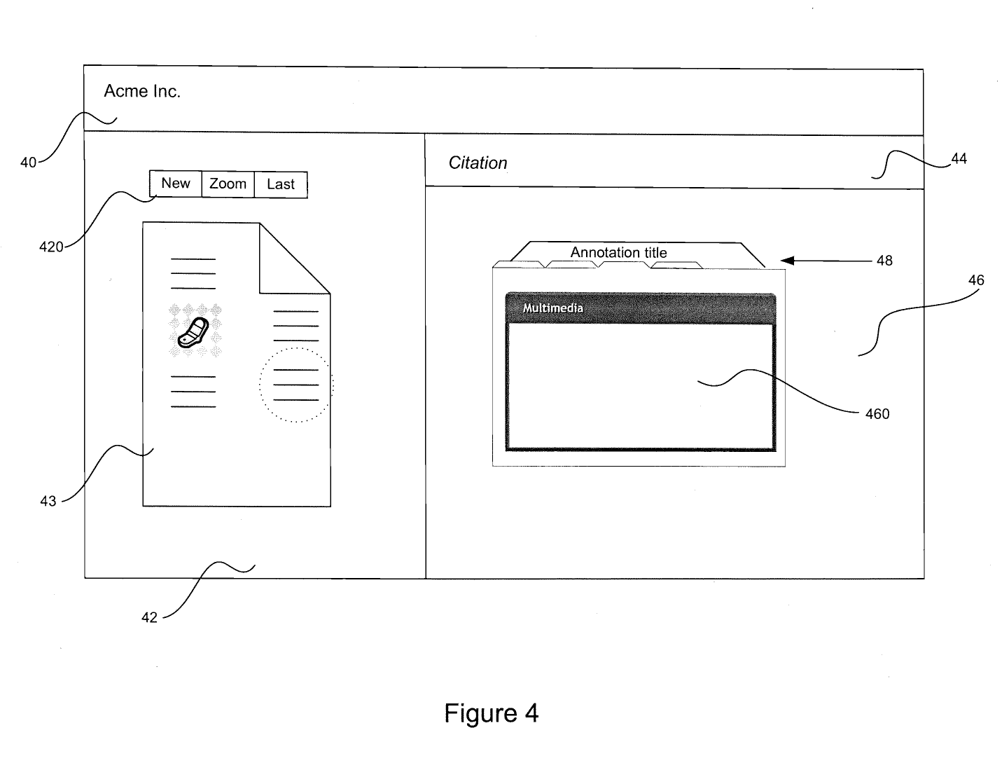

As shown in the example of FIG. 4, in certain embodiments a branding window 40 can be provided which a customer can brand with their corporate or organizational branding. In certain embodiments, an article window 42 is included in which an article 43 is presented such that it has the appearance of the original hard copy. At least half the screen space can typically be preserved for the article 43. In some embodiments, an article can be read without zooming.

The article can have various parts highlighted indicating that there is a set of annotations available for that part. Highlighted portions may comprise a paragraph, a sentence, a figure, a table, a graphic or any combination of these components. The tool can typically generate a highlight when a highlighted portion is exposed to view and a short description of the annotation may appear. For example, the brief description may be “experimental protocol” or “proof of efficacy.” When selected, the highlight can change to indicate that it is the currently selected portion or region of the document. The article can typically be inspected page by page. A dragable scrolling bar along the right may be provided so that one could have the bottom of a page displayed along with the top of the next page at once. Inspection may also be made a “page at a time.”

Whenever an annotated region of the article or document 43 is selected, the annotation window may be populated with corresponding annotations, typically organized as a sequence of folders or documents accessible by tabs. A short title may appear above the tabs and a short title may be provided in a rollover popup. A sequence of tab display may be predefined and in many embodiments, a user may navigate the annotations by selecting a current tab. Certain tabs may include summaries, key points, glossaries and contextual navigation within the document 43 and to other documents.

In certain embodiments, a Zoom function increases the magnification of the document 43 on display to facilitate ease of reading. The article/document 43 may be viewed using cursor controls and/or by clicking and dragging the article with a mouse. In certain embodiments, a PDF button can open the article/document 43 in a suitable reader such as Adobe Acrobat Reader. A separate window may be opened for viewing with a reader. In certain embodiments, a summary button may replace the document image 43 with a display of contextual summaries. In the example of pharmaceutical sales, the contextual summaries may comprise selling point summaries. In certain embodiments, a “Download to PDA” function is provided that downloads either the summaries or the PDF file to a PDA, depending which is displayed.

In certain embodiments, summaries can be provided as specialized flash movies or multimedia content. In the pharmaceutical sales example, the summaries may reiterate selling points and provide succinct graphs, tables, figures, and animations suitable for downloading to a Flash capable PDA. In this example, a “Selling Point Summary” button can be provided that, when clicked, causes the article window 42 to be populated with an array of small windows with independent Flash movies for each point that can be downloaded independently from the others. Thus, each summary may have a “select” box associated with it to indicate which to download when the “download” button is clicked. Each movie can typically fit into the footprint of a PDA (roughly 320×240) and be suitable for “beaming” to a sales prospect.

In one example, an annotation window is provided with sufficient resolution to support graphics displays on mobile devices such as a PDA. For example, the window may be sized to support a typical Flash animation (400-500 wide×500-600 tall). Any movie format is usable.

In certain embodiments, each annotation window/tab content module may be provided as an external file that can be easily changed without recompiling the entire annotator. Typically, each tab in the annotation window corresponds to one of the annotation types (these are generic names and are not intended to be the actual labels for the tabs as they are completely customizable):
Key point
Selling point
Visualization
Background
Glossary

In certain embodiments, clicking on a tab brings a corresponding annotation forward and may hide all other annotations. Where there is no content for an annotation category, the corresponding tab is typically grayed out and made unselectable (as opposed to having only the tabs appear for which content is available). Where an annotation cannot be displayed within Flash (such as a shockwave animation) or where loading of an annotation would be unduly time consuming (e.g. a video) or would require a separate window (such as a website), then that tab may have a static picture placeholder/button that allows the user to pop off the annotation into a separate window. In this manner a large, lengthy, or distracting annotation need not be visible unless desired by the user.

In many embodiments, the title provided above the annotation tabs may be a descriptive reference back to the article in the article window. This reference is typically a link whereby clicking it will refocus the article back to the part corresponding to the annotation. Thus, if the user gets lost in the document, they can reorient themselves easily.

A Glossary tab may provide global or local glossaries and may be provided as a contextual glossary. Glossary terms can be provided with a pronunciation guide. In certain embodiments, links in the article window 42 can be associated with pop up definitions that respond to the proximate presence of a cursor. In certain embodiments a citation window 44 holds the complete journal citation in a standard format. Typically the use of abbreviations of journal names is avoided and complete author names are used where possible. In some embodiments, an XML input mechanism can be employed.

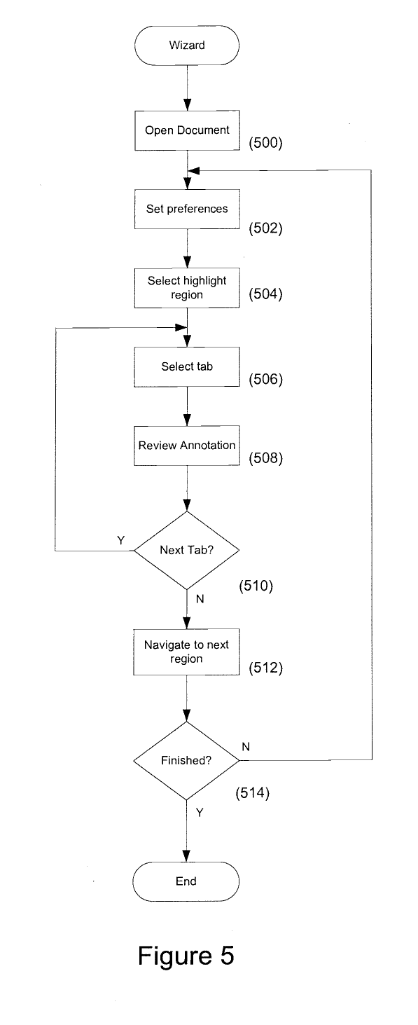

FIG. 5 illustrates an example of a process for navigating an annotated document according to aspects of the invention. At step 500, a user selects an annotated document for review. An image of the document 43 is provided in the article window 42, typically with certain view controls. At step 502, the user typically sets preferences for viewing the annotated document. Preferences can include zoom level, sequencing of review (e.g. sequential or contextual), automation of review using predetermined sequences, exclusions, links and whether the viewing is a first time viewing or a review. The preferences may also indicate a context for navigating the documents and whether the user is to be assessed on the viewing.

At step 504, the user selects a region to view in detail. Typically, the selected region will be highlighted or otherwise identified as having an associated annotation. Upon selection of a region, the selected region may be indicated as being the focus of review (e.g. may be presented in bold or colored highlights). Additionally, material may be presented in the annotation window 46. The initial display may be selected by sequence, preference, context or based on previous viewings of the document. The user may select one of a plurality of tabs 48 presented in the annotation window in order to view an annotation of interest; the selection of tabs may also be automated as determined by system configuration and/or user preference.

At step 508, information included in the annotation is presented. Presentation of the annotation information may be made using a text viewer, a document viewer, a multimedia player or any combination of presentation tools. Upon completion of review of the annotation, it is determined at step 510 whether the user wishes to select another tab or finish with the currently selected highlighted region at step 512. If the user chooses another region, then the annotation review steps are repeated. The user may also terminate the document review at step 514.

In certain embodiments, the process of FIG. 5 can be automated. Automation can be driven by a script provided by the system, by an educator or supervisor of the user, by the user and/or by the creator of the content. Automation typically permits the selection of annotated regions and annotation tabs in a predetermined sequence. Thus, the system can facilitate learning and can assist a user to attain familiarity with the document by guiding the user through the predetermined sequence. Typically, the predetermined sequence is calculated to mimic a manual presentation of the subject document (i.e. the document imaged) and the system can teach both the content of the document as well as the presentation of the document.

In certain embodiments, the system can be used to assess a user's familiarity with the document. For example, a user can be permitted to select some or all of the next annotated regions and annotation tabs for display. The selections can be recorded and reviewed at a later time by a supervisor or educator or by the user. Deviation from a preferred sequence of presentation can be highlighted and used to assist the user acquire a desired level of familiarity with the document and the presentation sequence.

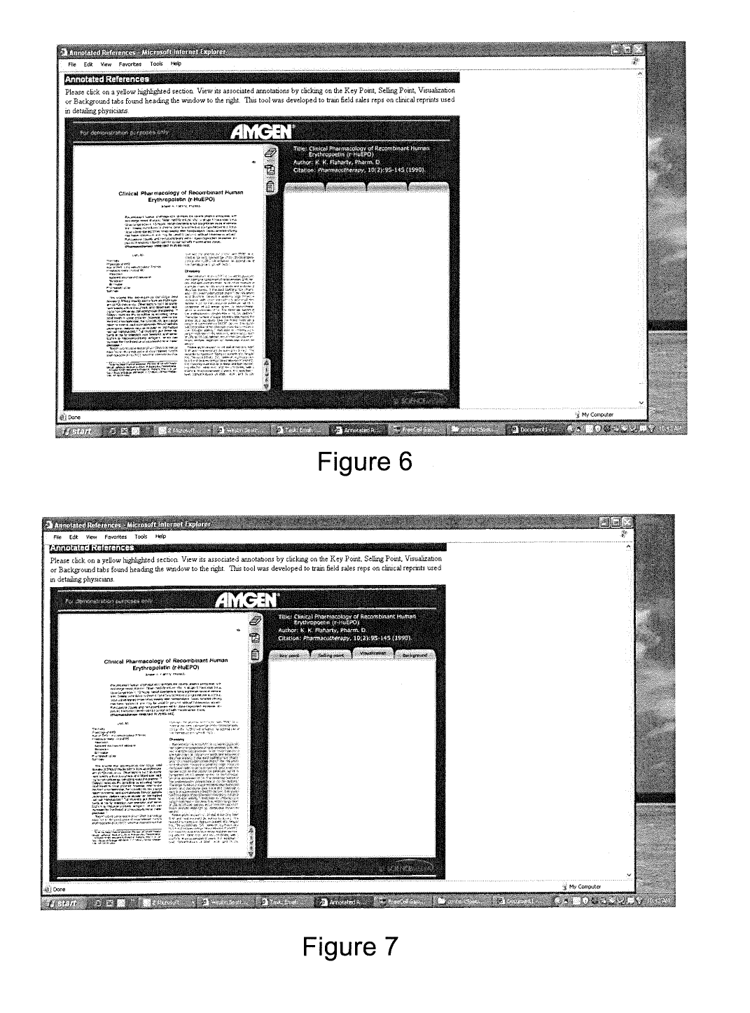

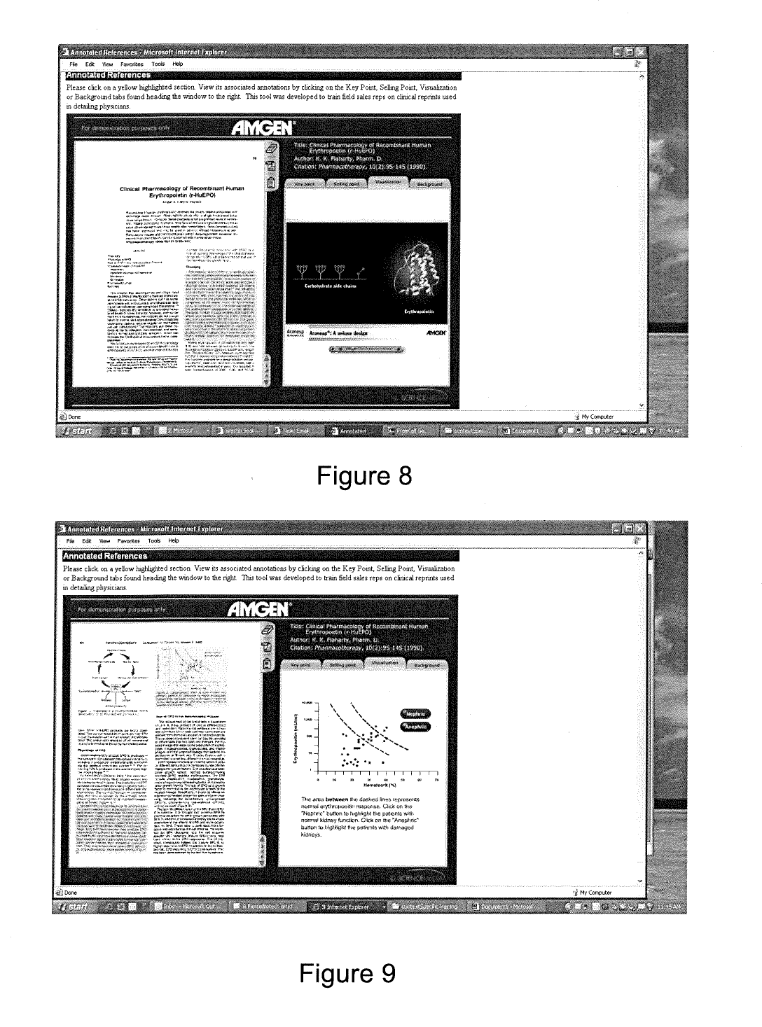

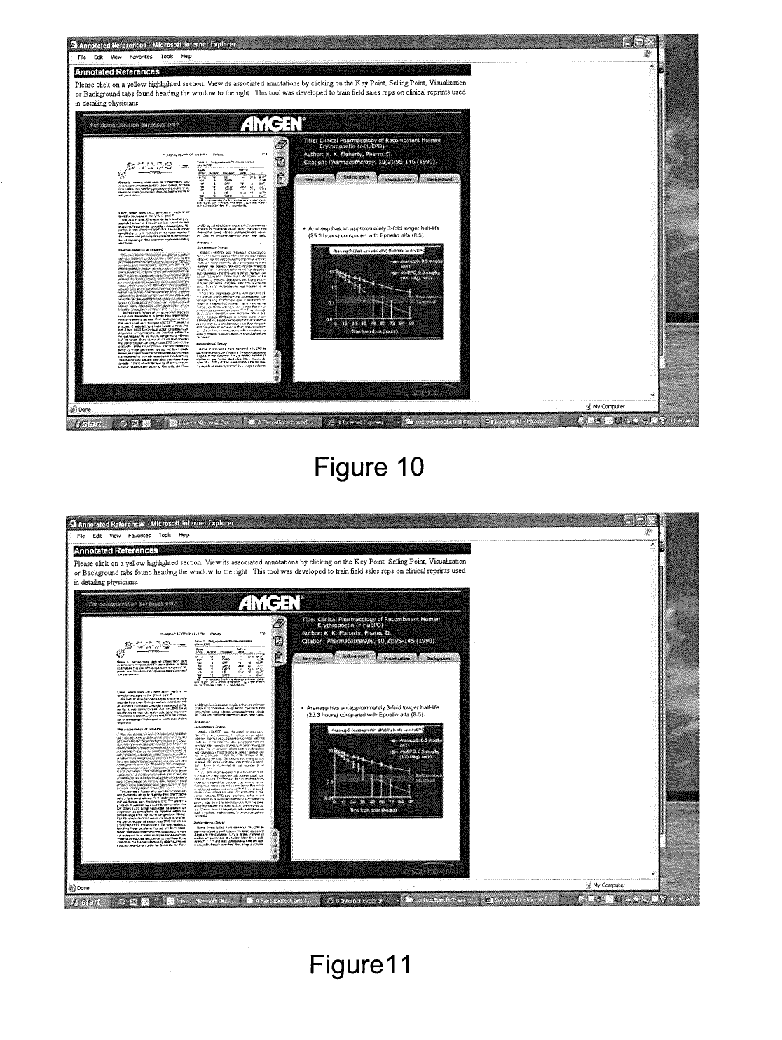

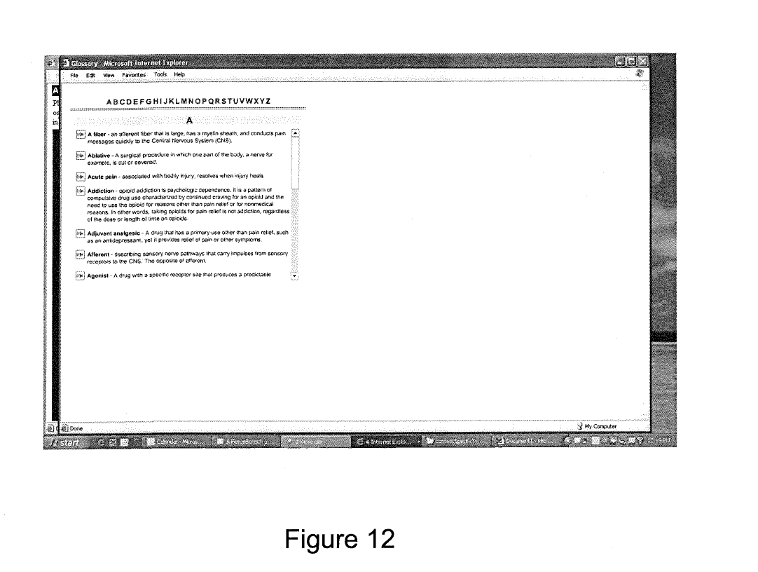

FIGS. 6-9 are screen shots captured from one embodiment of the invention.

The systems and methods describe have wide applicability. Certain embodiments can be configured by industry/business segment including pharmaceutical sales and training, training for complex document preparation (e.g. real estate transactions, loan initiation and tax preparation). Systems and methods described herein can be used as part of a formal, supervised training program and can also be used for self-directed training. Furthermore, the systems and methods can be used to develop training programs related to complex documents.

It is apparent that the above embodiments may be altered in many ways without departing from the scope of the invention. Further, various aspects of a particular embodiment may contain patentably subject matter without regard to other aspects of the same embodiment. Additionally, various aspects of different embodiments can be combined together. Also, those skilled in the art will understand that variations can be made in the number and arrangement of components illustrated in the above diagrams. It is intended that the appended claims include such changes and modifications.

### ADDITIONAL DESCRIPTIONS OF CERTAIN ASPECTS OF THE INVENTION

Certain embodiments provide systems and methods for annotating documents, comprising scanning a document to obtain a document image, annotating selected portions of the document and storing the document image, the annotation tabs and the associated information in an annotated document file. In some embodiments, annotating each portion includes identifying a location of the each portion, generating annotation tabs for the each portion, and associating the annotation tabs with information related to a region of the document corresponding to the each portion. In some of these embodiments, the information includes multimedia content and the associating includes identifying a multimedia player for playing the multimedia content. In some of these embodiments, the multimedia content and the identity of the multimedia player are accessed through one of the annotation tabs. In some of these embodiments, the multimedia content includes video content. In some of these embodiments, the annotating further includes summarizing the information to obtain a summary of selected ones of the annotation tabs. Some of these embodiments further comprise creating a summary for the document based on the information associated with certain of the annotation tabs of the each portion. In some of these embodiments, the annotating includes providing a glossary of terms found in the annotation tabs. In some of these embodiments, the glossary includes links to other terms having a common context with the annotation terms. In some of these embodiments, the each portion is annotated with a portion of the glossary. In some of these embodiments, the glossary includes a pronunciation guides.

In some of these embodiments, a method for interactive learning is provided that comprises providing an image of a document to a user, wherein a portion of the image is linked to annotations to the document, providing annotation tabs, each tab identifying one of the linked annotations, and responsive to selection of an annotation tab, presenting the annotation identified by the selected annotation tab. In some of these embodiments, the selection of the selected annotation tab is made by the user. In some of these embodiments, the selection of the selected annotation tab is made automatically. In some of these embodiments, successive selections of the user are recorded for subsequent assessment of user familiarity with the document. In some of these embodiments, annotation tabs are selected according to an automated sequence. In some of these embodiments, the annotation comprises a video clip and the selected annotation tab identifies a media player. In some of these embodiments, the annotation tab includes a glossary. In some of these embodiments, the glossary provides links to other annotations sharing a common context with the selected annotation tab.

In some of these embodiments, a system for interactive learning and assessment is provided that comprises a plurality of annotations to a document, and a presentation tool configured to display an image of the document and content provided by a selected annotation, wherein the annotation is selected from the annotated image, wherein portions of the image are highlighted and linked to corresponding ones of the annotations. In some of these embodiments, the system comprises a wizard component configured to identify additional portions of the image for highlighting and further configured to create links between the additional portions and information associated with corresponding regions of the document. In some of these embodiments, the wizard component generates one or more annotation tab for each of the additional portions, wherein each tab is associated with different information. In some of these embodiments, the wizard component generates one or more annotation tab for each of the additional portions, wherein a tab is generated for each type of information in the information.

What is claimed is:

1. A method for annotating documents, comprising:
scanning a document to obtain a document image;
annotating selected portions of the document, wherein for each portion, the annotating includes
identifying a location of the each portion,
generating annotation tabs for the each portion, and
associating the annotation tabs with information related to a region of the document corresponding to the each portion; and
storing the document image, the annotation tabs and the associated information in an annotated document file.

2. The method of claim 1, wherein the information includes multimedia content and the associating includes identifying a multimedia player for playing the multimedia content.

3. The method of claim 2, wherein the multimedia content and the identity of the multimedia player are accessed through one of the annotation tabs.

4. The method of claim 2, wherein the multimedia content includes video content.

5. The method of claim 1, wherein the annotating further includes summarizing the information to obtain a summary of selected ones of the annotation tabs.

6. The method of claim 5, and further comprising creating a summary for the document based on the information associated with certain of the annotation tabs of the each portion.

7. The method of claim 1, wherein the annotating includes providing a glossary of terms found in the annotation tabs.

8. The method of claim 7, wherein the glossary includes links to other terms having a common context with the annotation terms.

9. The method of claim 7, wherein the each portion is annotated with a portion of the glossary.

10. The method of claim 9, wherein the glossary includes a pronunciation guides.

11. A method for interactive learning, comprising:
providing an image of a document to a user, wherein a portion of the image is linked to annotations to the document;
providing annotation tabs, each tab identifying one of the linked annotations; and
responsive to selection of an annotation tab, presenting the annotation identified by the selected annotation tab.

12. The method of claim 11, wherein the selection of the selected annotation tab is made by the user.

13. The method of claim 11, wherein the selection of the selected annotation tab is made automatically.

14. The method of claim 13, wherein successive selections of the user are recorded for subsequent assessment of user familiarity with the document.

15. The method of claim 13, wherein annotation tabs are selected according to an automated sequence.

16. The method of claim 11, wherein the annotation comprises a video clip and the selected annotation tab identifies a media player.

17. The method of claim 11, wherein the annotation tab includes a glossary.

18. The method of claim 17, wherein the glossary provides links to other annotations sharing a common context with the selected annotation tab.

19. A system for interactive learning and assessment, comprising:
a plurality of annotations to a document; and
a presentation tool configured to display an image of the document and content provided by a selected annotation, wherein the annotation is selected from the annotated image, wherein portions of the image are highlighted and linked to corresponding ones of the annotations.

20. The system of claim 19, and further comprising a wizard component configured to identify additional portions of the image for highlighting and further configured to create links between the additional portions and information associated with corresponding regions of the document.

21. The system of claim 20, wherein the wizard component is configured to generate one or more annotation tab for each of the additional portions, wherein each tab is associated with different information.

22. The system of claim 20, wherein the wizard component is configured to generate one or more annotation tab for each of the additional portions, wherein a tab is generated for each type of information in the information.
